(19) United States
(12) Patent Application Publication
(10) Pub. No.: US 2012/0200128 A1
(43) Pub. Date: Aug. 9, 2012

(54) Safety Seat with Incorporated Mechanical Damping Element and Suspended on a Textile Support Frame

(76) Inventor: Gustavo Soliz, El Paso, TX (US)

(21) Appl. No.: 13/021,275

(22) Filed: Feb. 4, 2011

(51) Int. Cl. B60N 2/427; B63B 29/00; B64D 11/06

(52) U.S. Cl. 297/216.17

(57) ABSTRACT

A safety seat for land vehicles, aircraft and watercraft, including a seat frame that forms a seat portion; at least two textile support straps for mounting to a vehicle, with the seat frame being held in place on the support straps and sections of the support straps extending between securement locations on the seat frame and upper securement locations on the vehicle; at least one additional suspension strap that extends between the seat frame and an upper securement device on the vehicle; and a mechanically elongatable damping element incorporated in the suspension strap.

### BACKGROUND OF THE INVENTION

The present invention relates to a safety seat for land vehicles, aircraft and watercraft, and includes a seat frame that forms a seat portion and that is held in place on at least two textile support straps that are mounted to a vehicle.

A safety seat having the aforementioned features is described, for example, in DE 10 2008 005 422 B3. The safety seat described therein is provided with a seat frame that is comprised of a seat portion and a backrest frame. The backrest frame of this known seat is secured to two safety straps that extend vertically between anchors mounted to the roof of the vehicle and to the floor of the vehicle. In the context of the concretely described construction the support straps are embodied in a loop-like manner, whereby the loops of the support straps include a front strap that faces the safety seat, and a rear strap that appropriately extends at a distance from the front strap, with the front and rear straps respectively being alternatingly guided over an upper transverse member as well as a lower transverse member of the backrest frame in such a way that when the strap loops are tensioned, front strap and rear strap clamp the transverse members between them. In addition, the backrest frame is suspended on a strap that is secured to an anchor that is mounted to the vehicle and is disposed vertically above the safety seat. In so doing, the holding forces applied via the clamping of the transverse members of the backrest frame by the support straps basically already suffice to fix the safety seat in position on the vertical support straps without further components. This advantageously ensures that impacts that act in the vertical direction, in other words in the “Z” direction of a vehicle, for example caused by mine explosions, are absorbed by the support strap loops. On the whole, an increase of the vertical forces acting upon the safety seat therefore result in only a very slight vertical change in position, resulting in a dampening of the vertically acting forces by the elongation characteristics of the straps that are used.

With the known suspension of the safety seat exclusively on textile straps, and the uncoupling of the safety seat from the structure of the vehicle connected therewith, a good protection of an occupant seated on the safety seat can be realized during brief and energetic sudden impacts of the vehicle. However, the related results are not yet satisfactory when only slight stresses occur.

It is therefore an object of the present invention to further improve the energy reduction of a safety seat of the aforementioned general type, in particular by providing an energy absorption even at low impact stresses.

### BRIEF DESCRIPTION OF THE DRAWINGS

This object, and other objects and advantages of the present application, will appear more clearly from the following specification in conjunction with the accompanying schematic drawings, in which:

FIG. 1 shows a safety seat with a pertaining support strap arrangement as well as additional suspension straps;

FIG. 2 shows a different embodiment of the suspension strap arrangement in a partially schematic side view of the safety seat; and

FIG. 3 refers to the embodiment of FIG. 2 and shows the incorporation of the elongation element into a suspension strap.

### SUMMARY OF THE INVENTION

The basic concept of the present invention is that in addition to the support strap sections that extend between an upper securement location on the vehicle and a securement location on the seat frame, at least one suspension strap extends between an upper securement on the vehicle and the seat frame, wherein a mechanically elongatable damping element is incorporated in the suspension strap.

The present inventive configuration has the advantage that due to the provision of at least one additional suspension strap, which has incorporated therein a damping element, a kinetic energy that occurs can be converted into elongation energy due to an elongation of the pertaining damping element, so that the stress that acts upon a person that is sitting on the safety seat is reduced without there already being an impact upon the textile support framework for the seat that is comprised of the support straps. The additional suspension strap, with its mechanical damping element, thus supplements and improves the damping characteristics of the suspension of such safety seats. Hence, the occupants sitting upon the safety seats are protected not only against high energy impacts through the textile connection of the safety seat to the vehicle structure, but also against low energy impacts by the elongation of the damping element incorporated into the additional suspension strap. It is to be understood that by means of the selection of the material used for the damping element, the dimensioning of the damping element, and its disposition in the at least one suspension strap, it is possible to produce different retardation or delay actions, optimized to the respective application requirement, with respect to the required energy reduction and the thereby dictated elongation path of the damping element.

Pursuant to one preferred specific embodiment of the invention, in addition to the support strap sections that extend between the upper securement location on the vehicle and the securement locations on the seat frame, two additional suspension straps, with damping elements incorporated therein, are provided.

Pursuant to a first embodiment of the invention, the additional suspension strap, which is guided from an upper securement location on the vehicle to the seat frame, is divided into two portions, with the damping element being incorporated between the two portions. In particular, the two ends of the damping element are respectively secured to a portion of the suspension strap that leads from the damping element to the securement location mounted on the vehicle, and to a portion of the suspension strap that leads from the damping element to the securement location mounted on the seat frame.

Pursuant to an alternative embodiment, the ends of the damping element can be secured directly to the seat frame, so that it is then merely necessary to have a portion of the suspension strap that is guided from the other end of the damping element to the upper securement location that is mounted to the vehicle.

Pursuant to a preferred embodiment of the invention, care is taken that the elongation path available from the damping element when it is elongated can be limited or set. In particular, a strap portion is provided that bridges or spans the damping element and that has a stretch which on the one hand is greater than the dimension of the damping element in a not yet elongated state, yet is less than the dimension of the damping element after the latter has achieved its maximum elongation. This ensures on the one hand an adequate margin or allowance for the elongation of the damping element when it is stressed because the strap portion does not become effective. On the other hand, the strap portion fixes the maximum elongation path of the damping element because when a stretched or extended position of the strap portion is reached, even if further loads become effective no further elongation of the damping element is possible.

Pursuant to one specific embodiment, the strap portion can be a monolithic component of the suspension strap, and at least one eye or loop can be secured to the suspension strap for the securement of the damping element thereto.

Pursuant to a first embodiment, the two ends of the damping elements can be respectively secured to the spaced-apart eyes or loops that are provided on the suspension strap, whereby the strap portion that spans the damping element extends between the eyes or loops as a component of the suspension strap.

If pursuant to one embodiment of the invention one end of the damping element is secured directly to the seat frame, then for this case the end of the strap portion, which is a component of the suspension strap and that bridges or spans the damping element, and the associated end of the damping element, are together secured to the seat frame.

Pursuant to one embodiment of the invention the damping element can be embodied as a member or body having areas that in its unstressed state are precompressed, and when loads are encountered is elongatable by elongation of its precompressed areas. The present invention also encompasses every other embodiment of a damping element having an available elongation path.

It should be noted that it may be sufficient to secure the suspension straps to the backrest frame.

Further specific features of the present application will be described in detail subsequently.

### DESCRIPTION OF SPECIFIC EMBODIMENTS

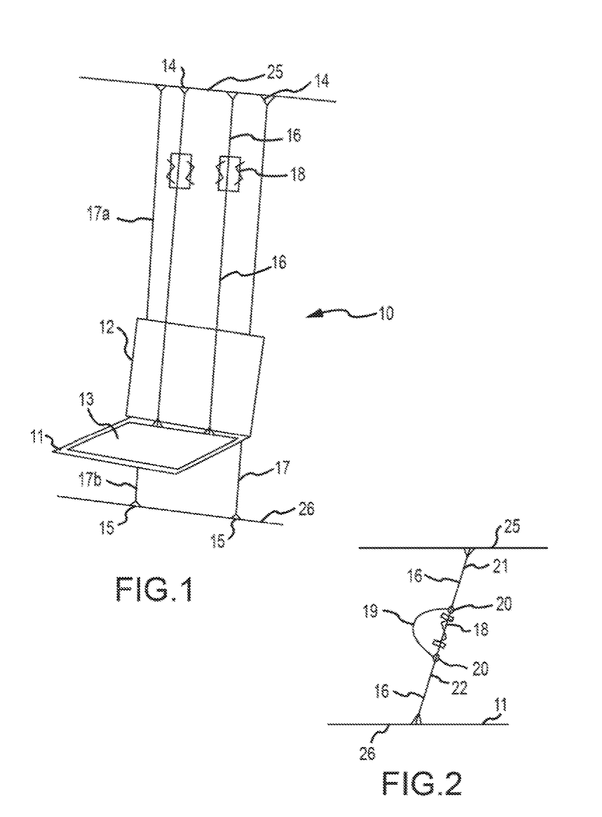

Referring now to the drawings in detail, the safety seat 10 shown in FIG. 1 is provided with a seat frame 11, which forms a seat portion 13, and with a backrest frame 12, which is connected to the seat frame 11 and forms a backrest. Support straps 17 are provided to support the safety seat 10 between a vehicle roof 25 and a vehicle floor 26. In this connection, sections 17a of the support straps run between the anchors 14 that are mounted on the roof and the backrest frame 12, while sections 17b of the support straps extend between the backrest frame 12 and the anchors 15 that are mounted on the floor. The suspension thus formed from a textile support framework is indicated only schematically; the details thereof can also be configured in a different manner.

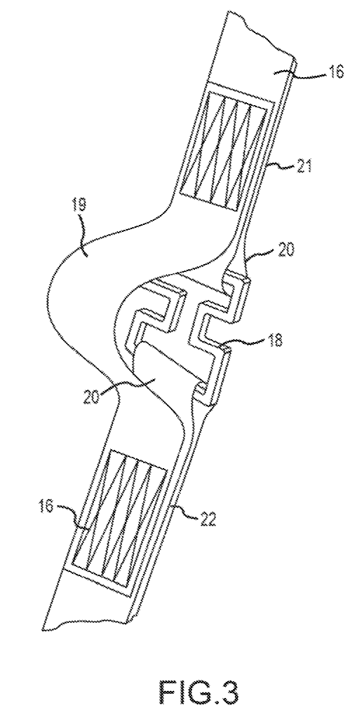

The important aspect for realizing the present invention is that two suspension straps 16 extend between further anchors 14 that are mounted to the roof and the seat frame 11; each of the suspension straps 16 has a respective damping element 18 incorporated therein. The damping element 18 can, for example, be embodied as a square or rectangular frame, wherein the side legs of the frame, which extend in the longitudinal direction, are provided with precompressed areas, so that when a load is introduced into the suspension strap 16, an elongation of the damping elements 18, simultaneously accompanied by extension, can occur. As can be seen from FIG. 1, this incorporation of the damping element 18 into each suspension strap 16 is realized in that a first portion 21 of the suspension strap 16 extends between the damping element 18 and the anchor 14 mounted to the roof, while a second portion 22 of the suspension strap 16 extends between the damping element 18 and the seat frame 11 (see for example FIG. 2).

Pursuant to an alternative embodiment, each damping element 18 can be connected directly to the seat frame 11, so that the associated suspension strap 16 extends between that end of the damping element 18 that faces the roof 25 and the anchor 14 that is mounted to the roof.

In order to be able to limit or set the elongation path of the damping element 18, pursuant to the embodiment illustrated in FIGS. 2 and 3 a strap portion 19 is provided that bridges or spans the damping element 18. This strap portion 19 is provided with an extension or stretch that on the one hand is greater than the extension or elongation of the damping element 18 in the non-stressed state, while at the same time the extension of the strap portion 19 is less than the maximum possible extension of the damping element 18 when it is stressed. This means that when the seat suspension is not stressed, the strap portion 19 exists as a type of loop.

To realize this embodiment, the strap portion 19 can be a monolithic or integral component of the suspension strap 16, i.e. of the upper or first portion 21 thereof, whereby secured to the suspension strap 16 are two spaced-apart eyes or loops 20, which serve for holding the damping element 18 between them. The eyes 20 can be connected to the suspension strap 16.

When the suspension strap arrangement illustrated in FIG. 2 is stressed, first an elongation of the damping element 18 can occur until the strap portion 19 has stretched and no longer permits a further elongation of the damping element 18.

The features of the subject matter of these documents disclosed in the preceding specification, the patent claims, the abstract and the drawings can be important individually as well as in any desired combination with one another for realizing the various embodiments of the present invention.

The present invention is, of course, in no way restricted to the specific disclosure of the specification and drawings, but also encompasses any modifications within the scope of the appended claims.

What I claim is:

1. A safety seat for land vehicles, aircraft and watercraft, comprising:
a seat frame that forms a seat portion;
at least two textile support straps adapted to be mounted to a vehicle, wherein said seat frame is held in place on said support straps, further wherein sections of said support straps extend between a respective securement location on said seat frame and upper securement locations on the vehicle;
at least one additional suspension strap that extends between said seat frame and an upper securement device on the vehicle; and
a respective mechanically elongatable clamping element incorporated in said at least one additional suspension strap.

2. A safety seat according to claim 1, which includes two of said additional suspension straps, each of which is provided with a respective one of said damping elements.

3. A safety seat according to claim 1, wherein said at least one suspension strap has a first portion that extends from said damping element to said upper securement device on the vehicle, further wherein said at least one suspension strap has a second portion that extends from said damping element to a securement location on said seat frame, further wherein one side of said damping element is secured to said first portion of said suspension strap, and wherein an opposite side of said damping element is secured to said second portion of said suspension strap.

4. A safety seat according to claim 1, wherein said at least one suspension strap is provided with a portion that extends from said damping element to said upper securement location on the vehicle, further wherein one side of said damping element is secured to said portion of said suspension strap, and wherein an opposite side of said damping element is secured to said seat frame.

5. A safety seat according to claim 1, wherein said at least one suspension strap is provided with a strap portion that spans said damping element, further wherein said strap portion of said suspension strap has an extension that is greater than a dimension of said damping element in a non-elongated state of said damping element, and wherein said strap portion of said suspension strap has an extension that is less than a dimension of said damping element after a maximum elongation of said damping element.

6. A safety seat according to claim 5, wherein said strap portion of said suspension strap is an integral component of said suspension strap, and wherein said suspension strap is provided with at least one eye or loop for securement of said damping element thereon.

7. A safety seat according to claim 6, wherein said suspension strap is provided with two spaced-apart ones of said eyes or loops, further wherein opposite sides of said damping element are respectively secured to one of said eyes or loops, and wherein said strap portion of said suspension strap extends between said eyes or loops.

8. A safety seat according to claim 6, wherein an end of said strap portion of said suspension strap, and an associated end of said damping element, are secured in common to said seat frame.

9. A safety seat according to claim 1, wherein said damping element is embodied as a member having areas that are precompressed in an unloaded state of said damping element, and wherein said member is elongatable when said damping element encounters a load by elongation of said precompressed areas.

10. A safety seat according to claim 1, wherein said at least one suspension strap is secured to a backrest frame.
